(19) United States
(12) Patent Application Publication
(10) Pub. No.: US 2010/0241885 A1
(43) Pub. Date: Sep. 23, 2010

(54) Method, system and apparatus for controlling power consumption of embedded system

(75) Inventors: Shiming He, Shenzhen (CN); Yu Liu, Shenzhen (CN); Cong Yao, Shenzhen (CN); Xiang Li, Shenzhen (CN); Liqian Chen, Shenzhen (CN); Jiayin Lu, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/725,281

(22) Filed: Mar. 16, 2010

(30) Foreign Application Priority Data
Mar. 18, 2009 (CN) 200910129422.8

(51) Int. Cl. G06F 1/30; G06F 13/24

(52) U.S. Cl. 713/322; 710/267; 713/340

(57) ABSTRACT

Embodiments of the present disclosure disclose a method for controlling power consumption of an embedded system. The method obtains a data transmission index that is between a bus module and a bus, compares the obtained data transmission index with a preset numeric value range, and adjusts an operation frequency or an operation voltage of the bus module when the data transmission index exceeds the preset numeric value range. Embodiments of the present disclosure further provide a system and a relevant apparatus for controlling power consumption of the embedded system. In comparison with the conventional art, embodiments of the present disclosure effectively monitor the load of the bus module, and adjust the operation parameters of the module according to the monitoring result to enable the module to operate under proper operation parameters and to thereby reduce unnecessary power consumption.

### CROSS-REFERENCE TO RELATED APPLICATION

This application claims priority to Chinese Patent Application No. 200910129422.8, filed on Mar. 18, 2009, which is hereby incorporated by reference in its entirety.

### FIELD OF THE DISCLOSURE

The present disclosure relates to the field of electronics, and more particularly to a method, a system and an apparatus for controlling power consumption of an embedded system.

### BACKGROUND OF THE DISCLOSURE

With ever increasing functions of handheld devices, various elements or module sets with increased functions have to be embedded into increasingly smaller devices, and system design is therefore rendered more complicated. For designers of handheld devices, it has become a problem how to enhance functionality without compromising the extension of the use life of batteries for handheld devices in the current circumstance that the increase in battery capacity is limited.

Extension of the use life of batteries for handheld devices must be achieved by reducing system load consumption. Various technical means are currently employed in the art to reduce power consumption. Among these means, dynamic voltage frequency scaling (DVFS) is the means that dynamically adjusts operation frequencies and operation voltages on demand of functions to effectively reduce dynamic power consumption.

The conventional technical solution, where DVFS is performed on the processor of a chip system, is as shown in FIG. 1. In the technical solution, a load monitor 102 of a processor 101 is embedded in the processor to monitor the load of the processor 101. In general, the load monitor 102 monitors such indices as the ratio of instructions executed by the processor to idle instructions, and the operation current of the processor, and sends the monitoring results of the indices to a DVFS module 103. Then, the DVFS module 103 dynamically adjusts the operation frequency and operation voltage of the processor once the DVFS module 103 has received the monitoring results of the indices sent by the load monitor. Thus, the power consumption of the processor 101 is dynamically adjusted.

The foregoing method has at least the following problem:

By using the method, the load of the processor is monitored, and the operation voltage or operation frequency of the processor is dynamically adjusted according to the monitoring results to effectively reduce the power consumption of the processor. However, the loads of other modules in the embedded system cannot be effectively monitored, such as the memory controller. This is because that the method is used to mainly monitor the processor and implement the DFVS. Other modules take an increasingly larger proportion in the entire System-on-Chip (SoC) with the rapid development, and the power consumed by these modules takes up a correspondingly increased proportion in the total power consumption of the system. Therefore, there is a need to figure out a method for controlling power consumption, which is applicable to both the processor and other modules in an embedded system.

### SUMMARY

A method for controlling power consumption of an embedded system comprises the following: obtaining a data transmission index that is between a bus module and a bus, comparing the data transmission index with a preset numeric value range, and adjusting an operation frequency or an operation voltage of the bus module when the data transmission index exceeds the preset numeric value range.

An embedded system comprises a load monitor, configured to obtain a data transmission index that is between a bus module and a bus, compare the obtained data transmission index with a preset numeric value range, and send an interruption signal when the data transmission index exceeds the preset numeric value range, and an adjusting module, configured to adjust an operation frequency or an operation voltage of the bus module after receiving the interruption signal.

A load monitor comprises a comparison logic, configured to compare a data transmission index that is between a bus module and a bus with a preset numeric value range, and send triggering information when the data transmission index exceeds the preset numeric value range, and an interruption control logic, configured to generate and send an interruption signal that triggers adjustment of an operation frequency or an operation voltage of the bus module, after receiving the triggering information.

### BRIEF DESCRIPTION OF THE DRAWINGS

To explain the technical solutions of the embodiments of the present disclosure or the conventional art in a clearer manner, drawings necessary for illustration of the embodiments of the present disclosure or the conventional art are briefly provided below. Obviously, the drawings described below are merely directed to certain embodiments of the present disclosure. Moreover, it is possible for a person ordinarily skilled in the art to obtain other drawings based on these drawings without making creative effort.

FIG. 1 is a schematic diagram of the module structure for adjusting the operation parameters of a processor according to the conventional art;

FIG. 2 is a flowchart illustrating adjustment of the operation parameters of a bus module according to a specific embodiment of the present disclosure;

FIG. 3 is a schematic diagram illustrating the connection for monitoring the load of a bus module according to a specific embodiment of the present disclosure;

FIG. 4 is a schematic diagram of the internal structure of a load monitor according to a specific embodiment of the present disclosure; and

FIG. 5 is a flowchart illustrating adjustment of the operation parameters of the bus module according to a specific embodiment of the present disclosure.

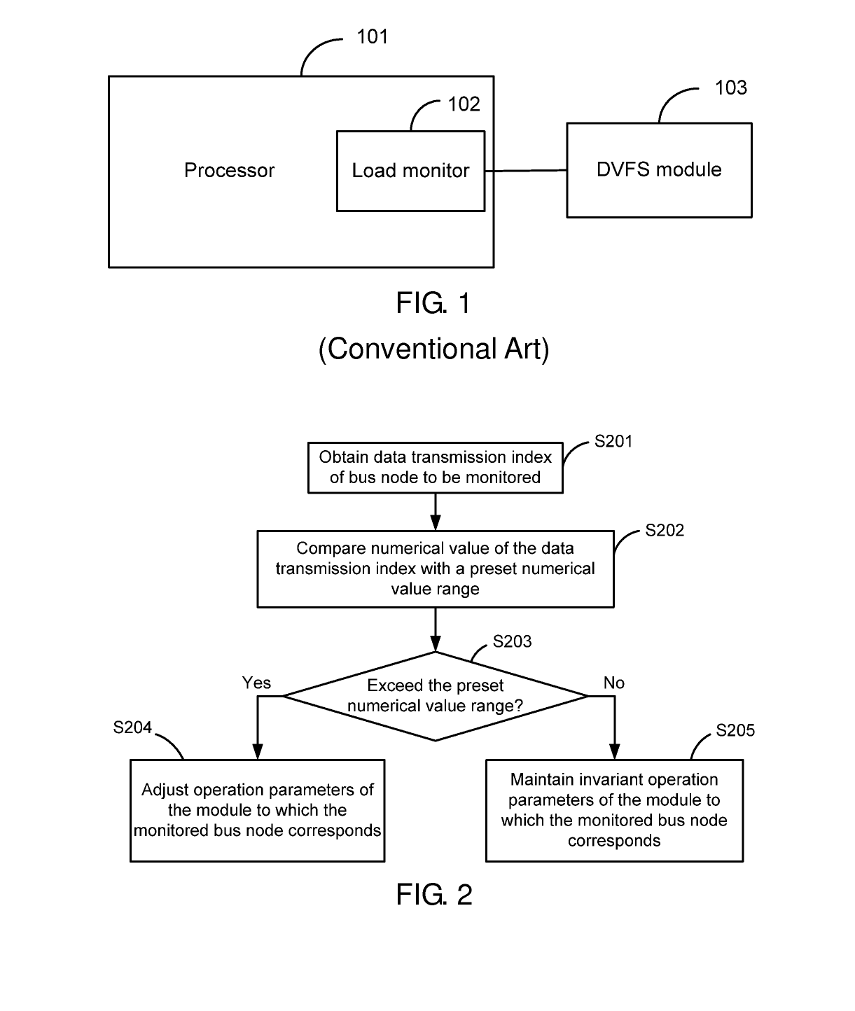

### DETAILED DESCRIPTION OF THE DISCLOSURE

The technical solutions according to the embodiments of the present disclosure are described in clarity and entirety with reference to the drawings. It is obvious that the embodiments described are only partial, rather than entire, embodiments of the present disclosure. All other embodiments obtainable by a person ordinarily skilled in the art based on the embodiments of the present disclosure and without creative effort fall within the protection scope of the present disclosure.

Based on correlation of data throughputs between the bus module and the bus, it is possible in the embedded system to monitor the load of a bus module by monitoring the bus node that corresponds to the bus module, and to dynamically adjust the operation parameters of the bus module according to the monitoring result. In this way, the power consumption of the bus module can be reduced. The bus module in the embodiments of the present disclosure is a module that transmits data through the system bus, and is in particular a bus-intensive module in the embedded system. For example, the bus module can be a processor, a memory controller, a graph accelerator, or an audio/video decoder. Specific steps are as shown in FIG. 2, and include:

Step S201: A data transmission index of the bus node to be monitored is obtained.

In step S201, the data transmission index of the bus node can either be the data transmission times of the node, or various relevant indices such as data traffic of the node.

Steps S202-S203: The obtained data transmission index of the bus node is compared with a preset numeric value range. If the data transmission index exceeds the preset numeric value range, the process goes to step S204. If the data transmission index does not exceed the preset numeric value range, the process goes to step S205.

The data transmission index of the bus node can specifically be such relevant index as the bus transmission times of the node or data traffic of the node. It is supposed that the bus transmission times of the bus node to be monitored is currently obtained. This obtained numeric value is compared with the preset numeric value range of the bus transmission times, and the subsequent operation is carried out according to the comparing result. If the data traffic of the bus node to be monitored is obtained, the operations performed are similar to the operations performed when the bus transmission times of the bus node is obtained. Depending on different system circumstances, it is also possible to compare a plurality of relevant indices involved in the data transmission index and then synthesize the plurality of the comparing results to carry out the subsequent operation.

Step S204: The operation parameters of the bus module to which the monitored bus node corresponds are adjusted.

In this step, the relevant operation is performed according to the comparing result of steps S202-S203. That is, if the obtained data transmission index of the bus node is not within the preset numeric value range and greater than the upper limit of the preset range, the value of such operation parameter as the operation frequency or operation voltage of the module to which the bus node corresponds is increased; if the numeric value of the obtained data transmission information of the bus node is not within the preset numeric value range and smaller than the lower limit of the preset range, the value of such operation parameters as the operation frequency or operation voltage of the module to which the bus node corresponds is decreased.

Step S205: The operation frequency and operation voltage of the bus module to which the monitored bus node corresponds is maintained unchanged.

In the above process, the data transmission index between the bus module and the bus is obtained, the obtained transmission index is compared with the preset numeric value range, and the operation parameters of the module are dynamically adjusted according to the comparing result to enable the module to operate under proper operation parameters and to reduce unnecessary power consumption.

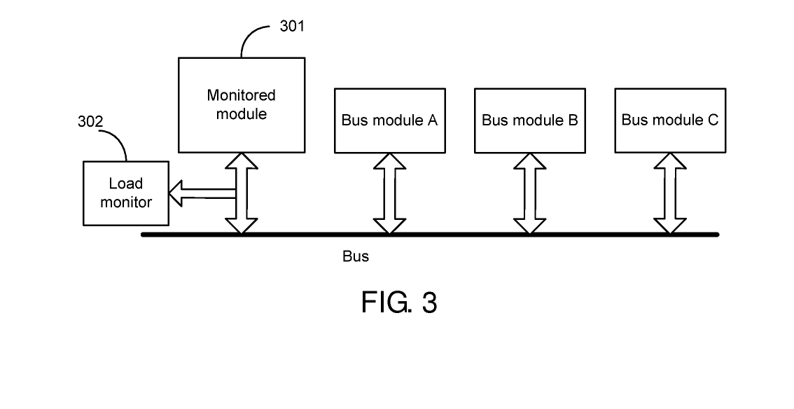

FIG. 3 is a schematic diagram illustrating the connection for monitoring the load of the bus module by employing the foregoing method. As shown in FIG. 3, the monitored module 301 is a bus module connected to the bus, and the load monitor module 302 is connected to the node between the monitored module and the bus to monitor the load of the monitored module.

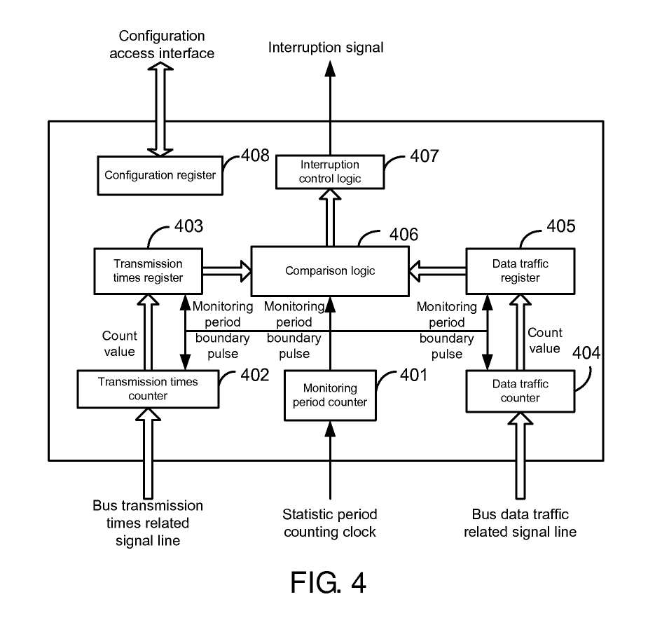

According to FIG. 3, the load monitor is the device essential for monitoring the load of the bus module. The specific internal structure and the interface of the device are described in details below. As shown in FIG. 4 that illustrates the internal structure of the load monitor, the load monitor includes:

a comparison logic 406, configured to obtain the data transmission index that is between the bus module and the bus, compare the data transmission index that is between the bus module and the bus with a preset numeric value range, and send triggering information when the data transmission index exceeds the preset numeric value range;

an interruption control logic 407, configured to generate and send an interruption signal that triggers adjustment of the operation frequency or operation voltage of the bus module after receiving the triggering information.

The load monitor may further include: (a) a monitoring period counter 401, configured to periodically time each module inside the load monitor; and (b) a configuration register 408, configured to receive load monitor configuration information, and configure the monitoring period counter and/or the comparison logic according to the load monitor configuration information.

The load monitor may still further include a transmission times counter 402, configured to determine whether the monitored module performs a read/write transmission operation with the bus within the monitoring period, accumulatively count the transmission times and output the count result, and clear the count value at a boundary of the monitoring period.

The load monitor may yet include a data traffic counter 404, configured to determine whether the monitored module performs a read/write data transmission operation with the bus within the monitoring period, accumulatively count the transmitted data traffic and output the count result, and clear a count value at a boundary of the monitoring period.

Still as shown in FIG. 4, the load monitor according to one embodiment of the present disclosure includes each of the modules that are shown in FIG. 4. Specifically, the modules are as follows:

The monitoring period counter 401 times a monitoring period, and outputs a pulse signal at the boundary of each monitoring period to start the relevant logic. This pulse signal is simultaneously outputted to the transmission times counter 402, the transmission times register 403, the data traffic counter 404, the data traffic register 405 and the comparison logic 406 to enable these modules to operate in a synchronization state.

The transmission times counter 402 determines whether there is a read/write transmission operation of the bus node within the monitoring period, accumulatively counts the transmission times, and clears the count value at the boundary of the monitoring period.

The transmission times register 403 samples the accumulated value of the transmission times obtained by the transmission times counter 402 at the boundary of the monitoring period, and sends the accumulated value to the comparison logic 406.

The data traffic counter 404 determines whether there is read/write data transmission of the bus node within the monitoring period, accumulatively counts the data traffic, and clears the count value at the boundary of the monitoring period.

The data traffic register 405 samples the accumulated value of the data traffic obtained by the data traffic counter 404 at the boundary of the monitoring period, and sends the accumulated value to the comparison logic 406.

The comparison logic 406 compares the transmission times and the data traffic received within the monitoring period with the preset numeric value range after the accumulated value that is monitored has been updated.

The interruption control logic 407 obtains the comparing result of the comparison logic 406 (the mode whereby it obtains the comparing result can be initiatively sending by the comparison logic 406), and generates and sends an interruption signal if the transmission times and the data traffic are not within the preset numeric value range.

The configuration register 408 configures each parameter index during the monitoring process, including configuring the monitoring period, configuring the numeric value range, and configuring the numeric value range comparison mode.

As should be noted, in other embodiments, after comparing the transmission times and the data traffic received within the monitoring period with the preset numeric value range, the comparison logic 406 further analyzes the comparing result, and sends the triggering information if the transmission times and the data traffic are not within the preset numeric value range. If the transmission times and the data traffic are within the preset numeric value range, the comparison logic 406, however, does not send the triggering information. The interruption control logic 407 generates and sends the interruption signal after receiving the triggering information. After the monitor ends, the operation parameters need to be adjusted according to the monitoring result to implement the control of the power consumption. Therefore, there is an adjusting module that is configured to adjust the operation parameters of the monitored module.

Since the operation parameters of the monitored module are changed, the various operation indices of the load monitor should be correspondingly adjusted. Therefore, a configuring module is required, which is configured to generate configuration information of the load monitor according to the adjusted operation parameters, and send the information to the configuration register 408.

As shown in FIG. 3, it is possible to provide a load monitor for each bus module to be monitored, as on the sub-bus shown by the arrow; and it is also possible to share one load monitor among a plurality of bus modules, where the load module is disposed on the bus shown in black line.

With reference to the aforementioned method and apparatus, technical solutions of the present disclosure are described in details below via load monitoring of an AMBA3 AXI bus node.

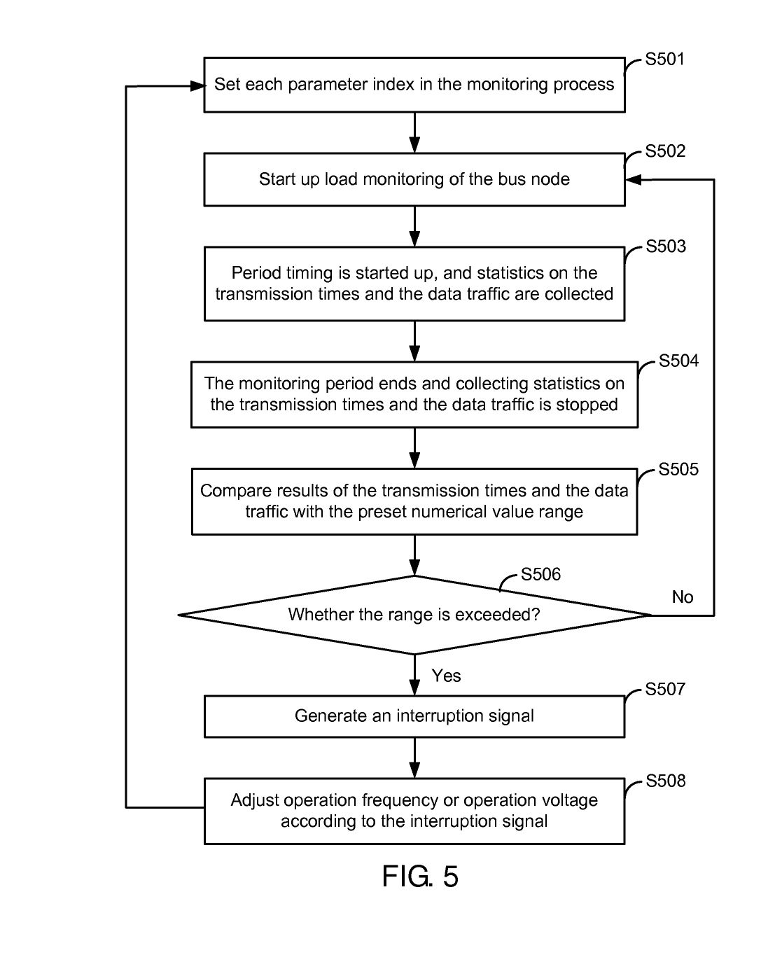

FIG. 5 illustrates a flowchart for this specific embodiment as follows.

Step S501: Each parameter index in the monitoring process is set, such as the duration of the monitoring period under the current frequency, transmission times range within one monitoring period, data traffic range within one period, comparing mode and statistics collecting result clearing mode.

During the setting of the duration of the monitoring period, because different systems are set according to different period step lengths and period maximum values, the monitoring period can be flexibly set according to the corresponding system operating status with the condition of satisfying an integral multiple of the period step length between the period step length and the period maximum value.

During the setting of the comparing mode, it is possible to set to reporting interruption once the transmission times or the data traffic exceeds the preset numeric value range according to the actuation situation, or set to reporting interruption when both the transmission times and the data traffic exceed the preset numeric value range, or set to only comparing the transmission times with the preset numeric value range to check whether the transmission times exceeds the preset numeric value range, in which case it is unnecessary to collect statistics on the data traffic, or set as comparing only whether the data traffic exceeds the preset numeric value range, in which case it is unnecessary to collect statistics on the transmission times.

Step S502: Load monitoring of the bus node is started up.

In this step, the period timer is cleared according to the setting in step S501. It is assumed that the comparing mode in step S501 is set to reporting interruption when both the transmission times and the data traffic exceed the preset numeric value range. In this case, it is necessary to simultaneously clear the transmission times counter and the data traffic counter.

Step S503: Period timing is started up, and statistics on the transmission times and the data traffic are collected at the same time.

Since load monitoring is performed on the AMBA3 AXI bus interface, and since the AXI bus can be subdivided into a total of five sub-buses of independent read/write data buses, read/write address buses and write return bus.

Therefore, when the statistics on the transmission times of the bus is collected, handshaking signals valid/ready, which are to be monitored, of read/write address channels include: (a) awvalid: valid mark of write address and control information; (b) awready: readiness for receiving write address and control information from a device; (c) arvalid: valid mark of read address and control information; and (d) arready: readiness for receiving read address and control information from the device.

The logic for determining the transmission times is that: (a) One write transmission is started up when the awvalid signal and the awready signal are both of high level at the rising edge of an clock signal aclk; and (b) One read transmission is started up when the arvalid signal and the arready signal are both of high level at the rising edge of the clock signal aclk.

Transmission times statistics is directed to the sum of read transmission and write transmission, while the read channel and the write channel in the AXI bus are independent of each other. Therefore, if the read transmission and the write transmission are simultaneously started up at the rising edge of the same clock signal aclk, the statistical value of the transmission times should be added by 2; if only the read transmission or the write transmission is started up, the statistical value of the transmission times should be added by 1. In other cases, no statistics is collected.

At the same time, when the statistics on the data traffic of the bus is collected, handshaking signals valid/ready, which are to be monitored, of read/write data channels include: (a) wvalid: write data being valid; (b) wready: readiness for receiving write data from a device; (c) rvalid: read data being valid; and (d) rready: readiness for receiving read data from the device.

The logic for determining the data traffic is that: (a) It indicates that writing data is successful for one time when the wvalid signal and the wready signal are both of high level at the rising edge of the clock signal aclk; and (b) It indicates that reading data is successful for one time when the rvalid signal and the rready signal are both of high level at the rising edge of the clock signal aclk.

Similar to statistics collection of the transmission times, if reading data and writing data are simultaneously successful at the rising edge of the same clock signal aclk, the statistical value of the data traffic should be added by 2; if only reading data or writing data is successful, the statistical value of the data traffic should be added by 1. In other cases, no statistics is collected.

Step S504: The monitoring period ends and collecting statistics on the transmission times and the data traffic is stopped.

Steps S505-S506: The statistics collecting results of the transmission times and the data traffic are compared with the preset numeric value range. If both the transmission times and the data traffic exceed the preset numeric value range, the process goes to step S507. If the transmission times and the data traffic do not exceed the preset numeric value range, the process goes to step S502.

When collecting statistics on the transmission times and the data traffic is stopped, the transmission times counter and the data traffic counter send the statistics collecting results respectively to the transmission times register and the data traffic register to complete data update of the transmission times register and the data traffic register. The transmission times register and the data traffic register send the result of collecting statistics on the transmission times and the result of collecting statistics on the data traffic to the comparison logic, and compare these results with the transmission times numeric value range and the data traffic numeric value range configured in advance in the comparison logic to obtain the comparing results and perform the corresponding subsequent operations.

In addition, as should be noted in these steps, it indicates that the preset numeric value range is incorrect when one of the transmission times and the data traffic is smaller than the preset lower limit, and the other one is greater than the preset upper limit. In this case, resetting is required.

Step S507: An interruption signal is generated, and each parameter index is set according to the adjusted operation frequency or operation voltage.

In this step, the interruption control logic module generates the corresponding interruption signal according to the comparing result sent from the comparison logic module.

Step S508: The operation frequency or the operation voltage of the bus module to which the bus node corresponds is adjusted according to the interruption signal generated in step S507.

Till now, the processes of load monitoring of the module to be monitored and adjustment of the operation parameters within one period are completed.

Likewise, load monitoring of the AMBA2 AHB bus node is carried out in the same process as AMBA3 AXI is monitored. There is, however, a great difference in data amount statistics of the transmission times because the specific signals monitored are different.

In the AHB bus, the bus clock signal is indicated by hclk, and signals to be monitored are mainly htrans[1:0] signal and hready signal, which respectively indicate the following: (a) htrans[1:0]: current transmission type signal, and including the following four types: 00: IDLE; 01: BUSY; 10: NONSEQ; 11: SEQ, of which NONSEQ indicates the initial data of the current transmission, and SEQ indicates non-initial data of the current transmission. and (b) hready: transmission status indication signal, and including the following two types: 1: transmission completed; 0: transmission uncompleted.

The logic for determining the transmission times is that: One transmission operation startup is indicated if hready signal is high and htrans is NONSEQ at the rising edge of the clock signal hclk.

Since it is impossible to simultaneously start up the read and write transmissions on the AHB bus, the statistical value of the transmission times is added by 1 at each transmission startup.

The logic for determining the data traffic is that: It indicates that one data transmission is valid if hready signal is high and htrans is NONSEQ or SEQ at the rising edge of hclk.

Since it is impossible to simultaneously read and write data on the AHB bus, the statistical value of the data traffic is added by 1 at each valid data transmission.

Since load monitoring of the AMBA2 AHB bus node is of the same flow as that of the AMBA3 AXI bus, no repetition will be made here.

As can be known from the above specific embodiments, the embodiments of the present disclosure obtain such data transmission index as the transmission times and transmission data traffic between the bus module and the bus to obtain the current operating load of the bus module, compare the obtained transmission index with the preset upper and lower limits, and dynamically adjust the operation parameters of the module according to the comparing result to enable the module to operate under proper operation parameters and to reduce unnecessary power consumption.

As understood by those skilled in the art, units and steps exemplarily illustrated with reference to the embodiments disclosed here can be realized by electronic hardware, computer software, or a combination of the two. To clearly explain the interchangeability of hardware and software, compositions and steps of the embodiments are generally described above according to functions. Whether these functions should be executed by hardware or by software depends on specific applications of the technical solutions and restrictive conditions of design. A person skilled in the art may implement the functions by using a different method for each specific application, but such implementation shall not be considered as going beyond the scope of the present disclosure.

The foregoing descriptions of the disclosed embodiments enable a person skilled in the art to implement or employ the present disclosure. Various modifications to these embodiments will be apparent to the person skilled in the art, and general principles defined here can be implemented in other embodiments without departing from the spirit or scope of the present disclosure. Therefore, the present disclosure shall not be restricted to the embodiments described here, and shall instead conform to the broadest scope that is consistent with the principles and novelty characteristics as disclosed here.

1. A method for controlling power consumption of an embedded system, comprising:
obtaining a data transmission index that is between a bus module and a bus;
comparing the data transmission index with a preset numeric value range; and
adjusting an operation frequency or an operation voltage of the bus module when the data transmission index exceeds the preset numeric value range.

2. The method according to claim 1, wherein the numeric value range is set according to the current operation voltage or operation frequency of the bus module, and the method further comprises:
resetting the numeric value range, after adjusting the operation frequency or the operation voltage of the bus module, according to the adjusting result.

3. The method according to claim 1, wherein the data transmission index between the bus module and the bus comprises data transmission times and/or data traffic between the bus module and the bus.

4. The method according to claim 1, wherein adjusting the operation frequency or the operation voltage of the bus module comprises:
raising the operation frequency or the operation voltage of the bus module if the comparing result indicates that the data transmission index is greater than a preset upper limit; or
lowering the operation frequency or the operation voltage of the bus module if the comparing result indicates that the data transmission index is less than a preset lower limit.

5. The method according to claim 1, wherein the bus module comprises a processor, a memory controller, a graph accelerator, or a decoder.

6. An embedded system, comprising:
a load monitor, configured to obtain a data transmission index that is between a bus module and a bus, compare the obtained data transmission index with a preset numeric value range, and send an interruption signal when the data transmission index exceeds the preset numeric value range; and
an adjusting module, configured to adjust an operation frequency or an operation voltage of the bus module after receiving the interruption signal.

7. The system according to claim 6, further comprising:
a configuring module, configured to generate load monitor configuration information according to the adjusted operation frequency or operation voltage to configure the load monitor.

8. The system according to claim 6, wherein the data transmission index between the bus module and the bus comprises data transmission times and/or data traffic between the bus module and the bus.

9. The system according to claim 6, wherein the load monitor comprises:
a comparison logic, configured to compare the received data transmission index with the preset numeric value range; and
an interruption control logic, configured to obtain the comparing result of the comparison logic, and generate and send an interruption signal when the data transmission index exceeds the preset numeric value range.

10. A load monitor, comprising:
a comparison logic, configured to obtain a data transmission index that is between a bus module and a bus, compare the data transmission index between the bus module and the bus with a preset numeric value range, and send triggering information when the data transmission index exceeds the preset numeric value range; and
an interruption control logic, configured to generate and send an interruption signal that triggers adjustment of an operation frequency or an operation voltage of the bus module, after receiving the triggering information.

11. The load monitor according to claim 10, further comprising:
a monitoring period counter, configured to periodically time each module inside the load monitor; and
a configuration register, configured to receive load monitor configuration information, and configure the monitoring period counter and/or the comparison logic according to the load monitor configuration information.

12. The load monitor according to claim 10, further comprising:
a transmission times counter, configured to determine whether a monitored module performs a read/write transmission operation with the bus within the monitoring period, accumulatively count the transmission times and output the result thereof, and clear a count value at a boundary of the monitoring period.

13. The load monitor according to claim 10, further comprising:
a data traffic counter, configured to determine whether a monitored module performs a read/write data transmission operation with the bus within the monitoring period, accumulatively count the transmitted data traffic and output the result thereof, and clear a count value at a boundary of the monitoring period.

14. The load monitor according to claim 12, wherein the bus is an AXI bus, and the transmission times counter adds by 1 the count value of the transmission times when it is determined that one write operation is present during simultaneous high level of an awvalid signal and an awready signal at a rising edge of a clock signal aclk, or adds by 1 the count value of the transmission times when it is determined that one read operation is present during simultaneous high level of an arvalid signal and an arready signal at the rising edge of the clock signal aclk; wherein
awvalid indicates a valid mark of write address and control information;
awready indicates readiness to receive write address and control information from a device;
arvalid indicates a valid mark of read address and control information; and
arready indicates readiness to receive read address and control information from the device.

15. The load monitor according to claim 13, wherein the bus is an AXI bus, and the data traffic counter adds by 1 the count value of the data traffic when it is determined that write data is successful during simultaneous high level of a wvalid signal and a wready signal at a rising edge of a clock signal aclk, or adds by 1 the count value of the data traffic when it is determined that read data is successful during simultaneous high level of a rvalid signal and a rready signal at the rising edge of the clock signal aclk; wherein
wvalid indicates that write data is valid;
wready indicates readiness to receive write data from a device;
rvalid indicates that read data is valid; and
rready indicates readiness to receive read data from the device.

16. The load monitor according to claim 12, wherein the bus is an AHB bus, and the transmission times counter adds by 1 the count value of the transmission times when it is determined that one transmission operation occurs at a rising edge of a clock signal hclk if a hready signal is high and htrans is NONSEQ; wherein
wherein hclk indicates a bus clock signal, hready indicates a transmission state indication signal, htrans indicates a current transmission type signal, and when htrans is 10, the type is indicated as NONSEQ, which indicates the initial data of the current transmission.

17. The load monitor according to claim 13, wherein the bus is an AHB bus, and the data traffic counter adds by 1 the count value of the data traffic when it is determined that one data transmission occurs at a rising edge of hclk if a hready signal is high and htrans is NONSEQ or SEQ.
